(19) United States
(12) Patent Application Publication
(10) Pub. No.: US 2016/0036870 A1
(43) Pub. Date: Feb. 4, 2016

(54) SESSION MANAGING METHOD, SESSION MANAGING SYSTEM, AND CALL PROCESSING METHOD

(71) Applicant: FUJITSU LIMITED, Kawasaki-shi (JP)

(72) Inventor: Kazuki MATSUI, Kawasaki (JP)

(73) Assignee: FUJITSU LIMITED, Kawasaki-shi (JP)

(21) Appl. No.: 14/745,937

(22) Filed: Jun. 22, 2015

(30) Foreign Application Priority Data
Jul. 30, 2014 (JP) 2014-155255
Apr. 22, 2015 (JP) 2015-087725

(51) Int. Cl. H04L 29/06; H04L 29/08

(52) U.S. Cl. CPC H04L 65/1086; H04L 67/143; H04L 67/145; H04L 67/146

(57) ABSTRACT

A session managing method executed by a session managing device, the session managing method includes: establishing a session with a communicating device in response to a first request from the communicating device; extending a duration limit of the session by a first time interval according to an actual result of communication between the communicating device and the session managing device; and extending the duration limit of the session by a second time interval longer than the first time interval when receiving, from the communicating device, a notification indicating that a telephone call with another communicating device is started.

### CROSS-REFERENCE TO RELATED APPLICATION

This application is based upon and claims the benefit of priority of the prior Japanese Patent Application No. 2014-155255, filed on Jul. 30, 2014, and the prior Japanese Patent Application No. 2015-087725, filed on Apr. 22, 2015, the entire contents of which are incorporated herein by reference.

### FIELD

Technologies disclosed in the present embodiments are related to technologies that manage a session.

### BACKGROUND

There has recently been a desire to utilize for example a smart device such as a smart phone, a tablet, or the like for business. There have been an increasing number of bring your own device (BYOD) cases where privately owned smart devices are used for business. For example, in a case where a privately owned smart phone is used for business, flexible switching between access to a business system and private use is desired to be realized while a secure state is ensured. Related technologies are disclosed in Japanese Laid-open Patent Publication No. 2011-61814 and Japanese Laid-open Patent Publication No. 2013-201670, for example.

### SUMMARY

According to an aspect of the invention, a session managing method executed by a session managing device, the session managing method includes: establishing a session with a communicating device in response to a first request from the communicating device; extending a duration limit of the session by a first time interval according to an actual result of communication between the communicating device and the session managing device; and extending the duration limit of the session by a second time interval longer than the first time interval when receiving, from the communicating device, a notification indicating that a telephone call with another communicating device is started.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram of assistance in explaining an example of a BYOD system;

FIG. 2 is a diagram of assistance in explaining an example of a session management table;

FIG. 3 is a diagram of assistance in explaining an example of a duration time management table;

FIG. 4 is a flowchart illustrating an example of processing operation of a relay server in relation to session management processing;

FIG. 5 is a flowchart illustrating an example of processing operation of a relay server in relation to session management processing at a time of an incoming call response;

FIG. 6 is a flowchart illustrating an example of processing operation of a user terminal in relation to business screen display processing;

FIG. 7 is a flowchart illustrating an example of processing operation of a user terminal at a time of an incoming call response;

FIG. 8 is a diagram of assistance in explaining an example of a hardware configuration of a relay server that executes a session managing program;

FIG. 9 is a diagram of assistance in explaining an example of a BYOD system;

FIG. 10 is a diagram of assistance in explaining an example of a management table;

FIG. 11A is a diagram of assistance in explaining an example of display screens of a user terminal;

FIG. 11B is a diagram of assistance in explaining an example of display screens of a user terminal;

FIG. 11C is a diagram of assistance in explaining an example of display screens of a user terminal;

FIG. 12A is a flowchart illustrating an example of processing operation of a CPU within a user terminal in relation to incoming call response processing;

FIG. 12B is a flowchart illustrating an example of processing operation of a CPU within a user terminal in relation to incoming call response processing;

FIG. 13 is a flowchart illustrating an example of processing operation of a CPU within a relay server in relation to providing processing; and

FIG. 14 is a diagram of assistance in explaining an example of a call terminal device that executes a call processing program.

### DESCRIPTION OF EMBODIMENTS

When there is a private incoming call to a smart phone owned by an individual during a session with a business system during which session a business application is used on the smart phone, for example, and a telephone conversation is directly performed in response to the incoming call, the session with the business system is disconnected. As a result, it may be necessary to perform an operation for reestablishing a session with the business system, or for example an operation of inputting a login identification (ID) and a password or the like. Thus, a great burden of the operation is imposed on the user.

In one aspect, it is an object of the technologies disclosed in the present embodiments to achieve compatibility between the duration of a session between a communicating device and a business system and telephone call connection at the communicating device.

Embodiments disclosed in the present application will hereinafter be described in detail with reference to the drawings. It is to be noted that the disclosed technologies is not limited by the present embodiments. In addition, the embodiments to be illustrated in the following may be combined with each other as appropriate within a scope in which no contradiction occurs.

Description will first be made of a mechanism in related art which mechanism is related to the duration and disconnection of a session between a communicating device as a user terminal and a server. Incidentally, the following description will be made by taking, as an example, a thin client system adopting a method of screen transfer by a relay server between a communicating device and a business system.

In the thin client system adopting the screen transfer method, the relay server transfers a request from the communicating device to the business system. When the relay server then receives a processing result from the business system, the relay server generates a screen for displaying the processing result, and transfers the screen data of the screen to the communicating device. The method of thus transferring the screen data generated by the relay server to the communicating device is generally referred to as a screen transfer method.

First, when the communicating device starts a business application, a negotiation for establishing a session is performed between the communicating device and the relay server according to a given protocol. Transmission control protocol/internet protocol (TCP/IP), for example, is adopted as the given protocol. In addition, when establishing the session, the user of the communicating device may need to input a password and a user ID.

Next, after the session is established, communication is started between the communicating device and the business system via the relay server. For example, the communicating device transmits a request to the relay server according to an input by the user. When the relay server then transfers the request to the business system, the business system performs processing according to the request. Next, obtaining a result of the processing from the business system, the relay server generates screen data such as a bit map or the like for displaying the processing result, and returns the screen data to the communicating device.

Receiving the screen data, the communicating device displays a business screen corresponding to the screen data, and returns an acknowledgement (Ack) signal (reception confirmation) notifying the reception of the screen data to the relay server. The series of pieces of processing is repeated while the session between the communicating device and the relay server is maintained. The user can thereby view results of processing by the business system and perform operations of the business system by using the communicating device.

In addition, the relay server manages the session with the communicating device, and maintains or disconnects the session. For example, the relay server monitors the communication between the communicating device and the relay server, and disconnects the session with the communicating device when no communication is performed over a certain time. That is, a time-out occurs, and the session is disconnected.

For example, when no Ack signal is received from a certain communicating device for a certain time, or when no request is received from a certain communicating device for a certain time, the relay server disconnects the session with the certain communicating device. This is intended to preferably prevent the resources of the relay server from being pressed when the relay server continues to maintain sessions with a large number of communicating devices.

For example, for each session, a memory area of the relay server is used, and also a central processing unit (CPU) is used. Hence, the larger the number of sessions maintained becomes, the more the resources of the relay server are pressed. Thus, disconnecting an unnecessary session releases resources on the relay server side, and therefore enables effective use of the resources of the relay server.

When session management by the above method is performed, in a case where there is an incoming call for a telephone conversation (hereinafter described simply as an “incoming call”) to the communicating device, and the user responds to the incoming call and performs a telephone conversation, for example, none of a request and an Ack signal from the communicating device is transmitted to the relay server. A time-out consequently occurs, so that the session is disconnected. Hence, the user may need to input a login ID and a password again after an end of the telephone conversation.

On the other hand, continuing to maintain the session with the business system unconditionally increases a risk of leakage of information, and is thus not desirable. Further, unnecessarily maintaining a session also leads to wasteful consumption of the resources of the server and the network. Accordingly, it may be necessary to improve the convenience of the user and extend the duration of a session according to conditions.

Accordingly, the technologies disclosed in the present embodiments provide mechanisms that maintain a session for a certain time even when a response to an incoming call is made on the communicating device side. For example, a technology disclosed in a first embodiment maintains, for a particular communicating device during a telephone call, a session between the communicating device and the relay server for a longer time than a normal time, by extending a time before a time-out occurs on the relay server side. A technology disclosed in a second embodiment preferably prevents the relay server from determining that a time-out has occurred and disconnecting the session by transmitting a packet for maintaining the session with the relay server from the communicating device side to the relay server side at intervals of a given time during a telephone call. Incidentally, continuing to maintain a session when a telephone call continues for a certain time or longer may lead to unnecessary use of resources on the relay server side. The following embodiments accordingly provide mechanisms that maintain a session for only a certain time longer than a normal time-out time from a start of a telephone call (start of response to an incoming call).

It is to be noted that the following embodiments are also applicable to thin client systems using secure communications, such as a virtual private network (VPN), secure sockets layer (SSL), and the like, other than thin client systems using the screen transfer method by the relay server. This is because these secure communications monitor a time-out in session units, and perform session management, as with the screen transfer method.

In addition to maintaining a session according to a start of a telephone call between a communicating device and another communicating device, a session may also be maintained in particular timing. For example, a session may be maintained when a different application (a telephone application, a mailer, a browser, or the like) other than the business application for accessing the business system is started while the business application is operating, and when it is detected that the business application has made a transition to a background.

### First Embodiment

The following description will be made supposing that the communicating device is a user terminal 300, that the relay server is a relay server 400, and that the business system is a business system 2. In a case where the user terminal 300 is a smart device privately owned by a user, a thin client system including the user terminal 300, the relay server 400, and the business system 2 is referred to as a BYOD system 1000. However, the user terminal 300 may be a smart device provided by a company or the like.

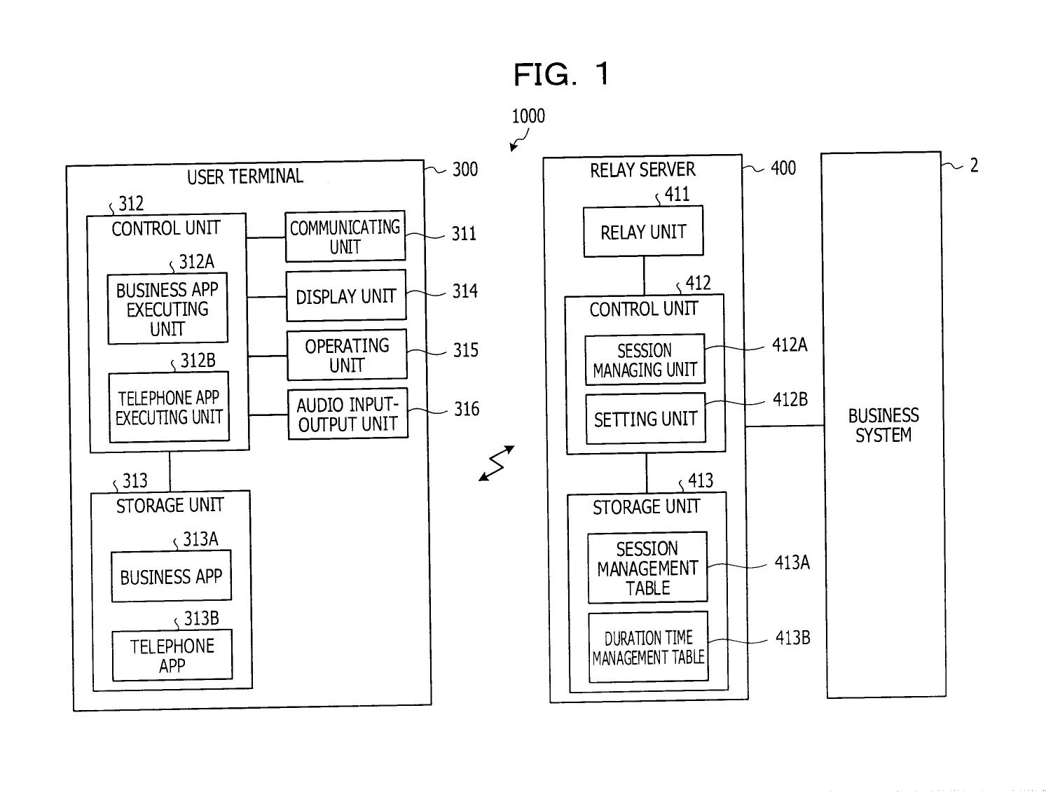

FIG. 1 is a diagram of assistance in explaining an example of a BYOD system. The BYOD system may be the BYOD system 1000. The BYOD system 1000 illustrated in FIG. 1 includes the business system 2, the user terminal 300, and the relay server 400. In the present embodiment, the BYOD system 1000 adopts the screen transfer method.

The user terminal 300 accesses the business system 2 via the relay server 400 using a specific application such as a business application (hereinafter referred to as a business app) or the like. The user terminal 300 is coupled to the relay server 400 by radio. In addition, the user terminal 300 is an example of a communicating device.

Further, the user terminal 300 receives screen data for displaying a result of processing by the business system 2 from the relay server 400, and displays a business screen corresponding to the screen data. Incidentally, it is desirable from a viewpoint of security to adopt a mechanism that does not leave the screen data within the user terminal 300 after the session between the user terminal 300 and the relay server 400 is disconnected.

The business system 2 is for example a specific system that manages business data within the company, and which allows various kinds of business in the company to be performed in a secure state. There may be a plurality of business systems 2.

The relay server 400 relays communication between the business system 2 and the user terminal 300. The relay server 400 is for example a gate way server providing a virtual web browser in a data center or the like. Incidentally, the relay server is an example of a session managing device.

The relay server 400 is for example coupled to the business system 2 by wire. Further, the relay server 400 enables the user terminal 300 to access the business system 2 in a secure state using the business app, and converts a processing result on the business system 2 side into screen data such as a bit map or the like and transfers the screen data to the user terminal 300. As described above, the relay server 400 enables remote operation of the business system 2 by the user terminal 300.

The relay server 400 includes a relay unit 411, a control unit 412, and a storage unit 413. The control unit 412 is for example a CPU. The storage unit 413 is for example a read only memory (ROM), a random access memory (RAM), and a hard disk drive (HDD).

The relay unit 411 relays screen data, commands, and the like mutually between the user terminal 300 and the business system 2.

The control unit 412 controls the whole of the relay server 400. For example, the control unit 412 controls the transfer of data between the user terminal 300 and the business system 2. The control unit 412 includes a session managing unit 412A and a setting unit 412B. The session managing unit 412A manages each session. For example, the session managing unit 412A sets a session duration time and monitors for a time-out of the session duration time for each session identified by an IP address and a port number.

For example, each time a request or an Ack signal is received from a user terminal 300, the duration time of a session with the user terminal 300 is extended by a first time interval. In addition, when an incoming call response is detected in a particular user terminal 300, the session duration time of a session with the particular user terminal 300 is extended by a second time interval larger than the first time interval. For example, the first time interval is one minute, and the second time interval is three minutes. Further, as for a session whose session duration limit has passed, the session managing unit 412A disconnects the session.

The setting unit 412B is a processing unit that sets the session duration time (second time interval) extended according to an incoming call response. For example, the second time interval may be uniform irrespective of the user terminal 300, or may be set for each of telephone numbers of callers of incoming calls.

For example, when the telephone number of a caller is the number of another user terminal 300 provided from the company to which the caller belongs as in the case of the user terminal 300, the session duration time is extended according to an incoming call response. A company generally manages the telephone numbers of user terminals 300 provided by the company. The setting unit 412B can therefore set the session duration time in association with the telephone number of a user terminal 300 provided by the company.

In addition, the setting unit 412B may set the session duration time for each business app 313A. For example, when the business app 313A being executed is a business app 313A that takes time to operate, it is presumed that the user takes more time to perform operation after an end of a telephone call. Therefore, the setting unit 412B improves the convenience of the user more by setting the session duration time for each business app 313A.

The storage unit 413 stores various kinds of information, a program, and the like. The storage unit 413 includes a session management table 413A and a duration time management table 413B.

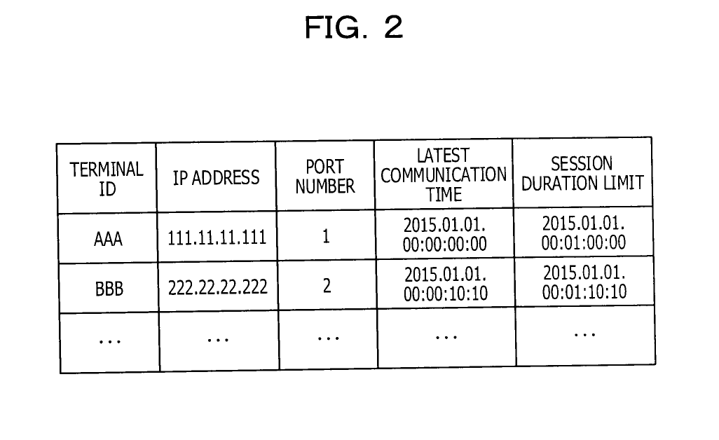

The session management table 413A is a table managed by the session managing unit 412A, and stores information for managing sessions with user terminals 300. FIG. 2 is a diagram of assistance in explaining an example of a session management table. The session management table illustrated in FIG. 2 may be the session management table 413A illustrated in FIG. 1.

The session management table 413A illustrated in FIG. 2 stores a terminal ID, an IP address, a port number, a latest communication time, and a session duration limit in association with each other. The terminal ID is information identifying the user terminal 300. The IP address is identifying information assigned to the user terminal 300 coupled to the network. The port number is information identifying a program used in TCP/IP communication. Incidentally, a session is identified by a combination of the IP address and the port number. The terminal ID, the IP address, and the port number are obtained from the user terminal 300 when a session is established.

The latest communication time indicates the time of a latest communication performed using the corresponding session. For example, each time a request is transmitted from the user terminal 300 to the relay server 400, and each time an Ack signal is transmitted from the user terminal 300 to the relay server 400, the session managing unit 412A updates the latest communication time corresponding to the user terminal 300.

The session duration limit represents a time limit until which the corresponding session is maintained. For example, the session managing unit 412A sets, as the session duration limit, a time obtained by adding the first time interval to the latest communication time. In addition, when an incoming call response is detected in the user terminal 300, the session managing unit 412A sets, as the session duration limit, a time obtained by adding the second time interval to a time at which the incoming call response is detected.

In the example of FIG. 2, in a session identified by an IP address “111.11.11.111” and a port number “1,” for example, the latest communication was performed at “2015.01.01, 00:00:00:00,” and the session duration limit is “2015.01.01, 00:01:00:00.” Incidentally, in the example of FIG. 2, the first time interval is one minute.

In addition, each time a new session is established, the session managing unit 412A adds a record corresponding to the new session in the session management table 413A. As for a session whose session duration limit has passed, the session managing unit 412A deletes the record of the session from the session management table 413A.

Returning to FIG. 1, the duration time management table 413B is a table managed by the setting unit 412B and referred to by the session managing unit 412A. The duration time management table 413B stores the session duration time (second time interval) for the user terminal 300.

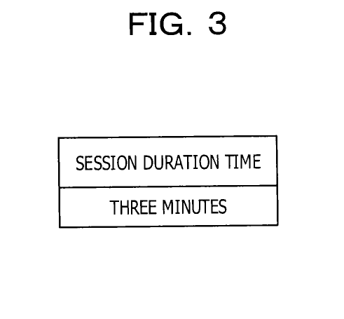

FIG. 3 is a diagram of assistance in explaining an example of a duration time management table. The duration time management table illustrated in FIG. 3 may be the duration time management table 413B illustrated in FIG. 1. The duration time management table 413B stores the session duration time for extending the session duration limit at a time of an incoming call response. The duration time management table 413B stores the information of “three minutes,” for example. Incidentally, the duration time management table 413B may also store the session duration time (normal session duration time) for extending the session duration limit when a response from the user terminal 300 is received, the session duration time (normal session duration time) corresponding to the first time interval.

Further, the duration time management table 413B may store a session duration time for each user terminal 300 in association with the terminal ID. In addition, the duration time management table 413B may store a session duration time for each business app in association with an application type that identifies the business app. Further, the duration time management table 413B may store a session duration time for each caller in association with the telephone number of the caller. Moreover, the duration time management table 413B may store session duration times according to time periods of incoming call responses and the number of user terminals using the relay server 400.

The setting unit 412B registers the session duration time in the duration time management table 413B according to an input of an administrator of the business system 2 and the relay server 400. The setting unit 412B may also register the session duration time in the duration time management table 413B according to an input from the user terminal 300.

Returning to FIG. 1, the user terminal 300 includes a communicating unit 311, a control unit 312, a storage unit 313, a display unit 314, an operating unit 315, and an audio input-output unit 316. The control unit 312 is for example a CPU. The storage unit 313 is for example a ROM, a RAM, and an HDD.

The communicating unit 311 is a communication interface in charge of radio communication with a base station and communication with the relay server 400, the communication with the relay server 400 using the business app. The display unit 314 is an output interface that performs screen display of various kinds of information. The operating unit 315 is an input interface that inputs various kinds of commands. The operating unit 315 for example corresponds to a touch panel that detects touch operation on the display screen of the display unit 314 or the like.

The audio input-output unit 316 for example corresponds to a microphone, a speaker, or the like, and corresponds to an input-output interface that inputs and outputs sound. The storage unit 313 for example stores the business app 313A and a telephone app 313B. The business app 313A is a specific app that establishes a session with the business system 2 via the relay server 400, enables access to the business system 2 in a secure state, and performs screen display of a business screen on the display unit 314. The telephone app 313B is an app that implements a telephone function using the radio communication of a carrier, for example. The telephone app 313B may be an app that implements a telephone call function using the Internet.

The control unit 312 controls the whole of the user terminal 300. A business app executing unit 312A performs various kinds of processing operation related to the business app 313A on the basis of the business app 313A. For example, the business app executing unit 312A establishes a session with the relay server 400. Further, after establishing the session, the business app executing unit 312A generates a request to the business system 2 on the basis of a user operation input from the operating unit 315. The business app executing unit 312A then transmits the request to the relay server 400 via the communicating unit 311.

In addition, when receiving a response (image data corresponding to a result of processing by the business system 2) from the relay server 400 via the communicating unit 311, the business app executing unit 312A controls the display unit 314 to display a business screen corresponding to the image data on the display unit 314.

Further, when receiving the response, the business app executing unit 312A returns an Ack signal to the relay server 400 via the communicating unit 311. Further, when detecting that a telephone app executing unit 312B has responded to an incoming call, the business app executing unit 312A notifies the relay server 400 via the communicating unit 311 that an incoming call response is detected.

The telephone app executing unit 312B performs various kinds of processing operation related to the telephone app 313B. For example, when the user gives an instruction to respond to an incoming call from a different communicating device (another user terminal 300), the telephone app executing unit 312B starts a telephone call with the different communicating device. In addition, when the user gives an instruction to end the telephone call, the telephone app executing unit 312B ends the telephone call.

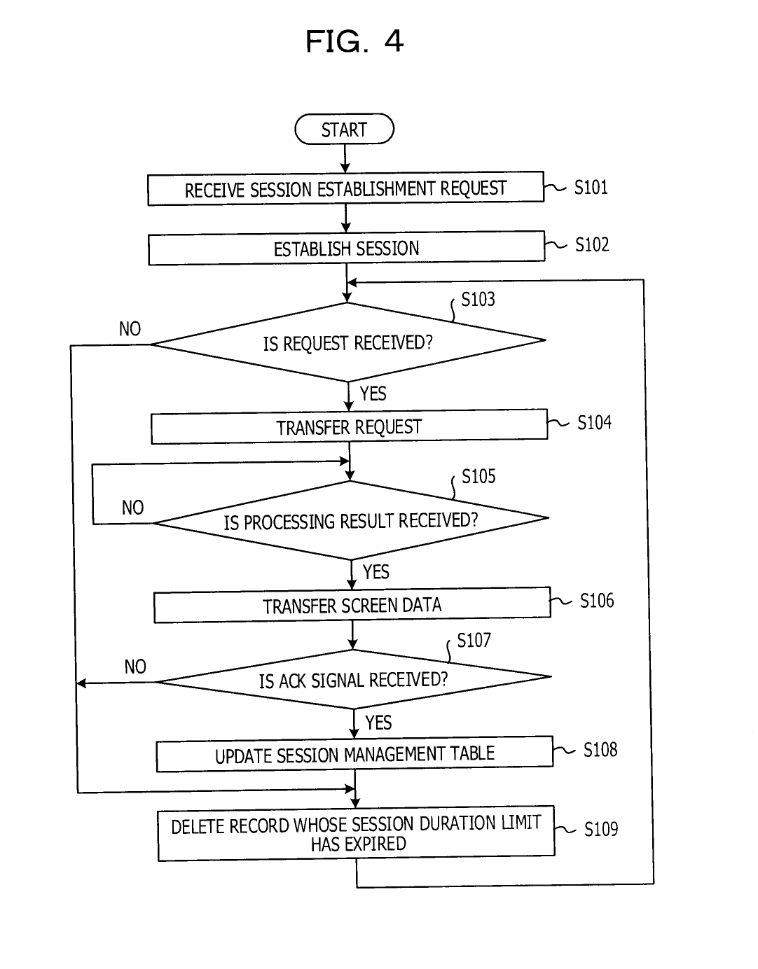

FIG. 4 is a flowchart illustrating an example of processing operation of a relay server in relation to session management processing. The relay server described with reference to FIG. 4 may be the relay server 400 illustrated in FIG. 1. The relay unit 411 receives a session establishment request from the user terminal 300 (S101). Incidentally, the session establishment request includes a terminal ID, an IP address, and a port number, and further includes a user ID and a password for accessing the business system 2.

The control unit 412 performs a negotiation with the user terminal 300, and establishes a session, according to a given protocol (for example TCP/IP) (S102). Then, the session managing unit 412A adds a new record related to the newly established session in the session management table 413A.

The control unit 412 determines whether or not a request is received from the user terminal 300 (S103). When a request is received (YES in S103), the control unit 412 controls the relay unit 411 to transfer the request to the business system 2 (S104). Next, the control unit 412 determines whether or not a response (processing result) in response to the request is received from the business system 2 (S105).

The control unit 412 waits until receiving a processing result (NO in S105). When the control unit 412 has received a processing result (YES in S105), the control unit 412 generates screen data for displaying the processing result. For example, the control unit 412 generates the screen data by generating a bit map that displays the processing result and further performing compression processing.

The relay unit 411 transfers the screen data to the user terminal 300 under control of the control unit 412 (S106). The session managing unit 412A next determines whether or not an Ack signal is received from the user terminal 300 (S107). Then, when an Ack signal is received (YES in S107), the session managing unit 412A updates the session management table 413A (S108). For example, the session managing unit 412A updates the latest communication time in the session management table 413A with the reception time of the Ack signal, and updates the session duration limit with a time obtained by adding the first time interval to the updated latest communication time (reception time of the Ack signal). This processing extends the session duration limit. Incidentally, the session managing unit 412A may update the session management table 413A in timing in which the request is received (YES in S103) other than the timing in which the Ack signal is received.

When no request is received in S103 (NO in S103), when no Ack signal is received in S107 (NO in S107), or when the updating of the session management table 413A is ended in S108, the session managing unit 412A deletes the record whose session duration limit has expired from the session management table 413A (S109). It suffices for the session managing unit 412A to identify the record whose session duration limit has expired by obtaining a present time and comparing the present time with the session duration limit in the session management table 413A.

Then, after S109 is ended, the control unit 412 returns to S103 to repeat the series of pieces of processing from S103 to S109. Incidentally, the session managing unit 412A may determine whether or not there is a record whose session duration limit has expired and delete the record whose session duration limit has expired from the session management table 413A at fixed time intervals independently of the flow illustrated in FIG. 4.

By the above processing, the relay server 400 can manage sessions, and disconnect a timed-out session. Hence, according to the present embodiment, the resources of the relay server 400 are used effectively by disconnecting a session with a user terminal 300 that has not communicated with the relay server 400 for a certain time or longer.

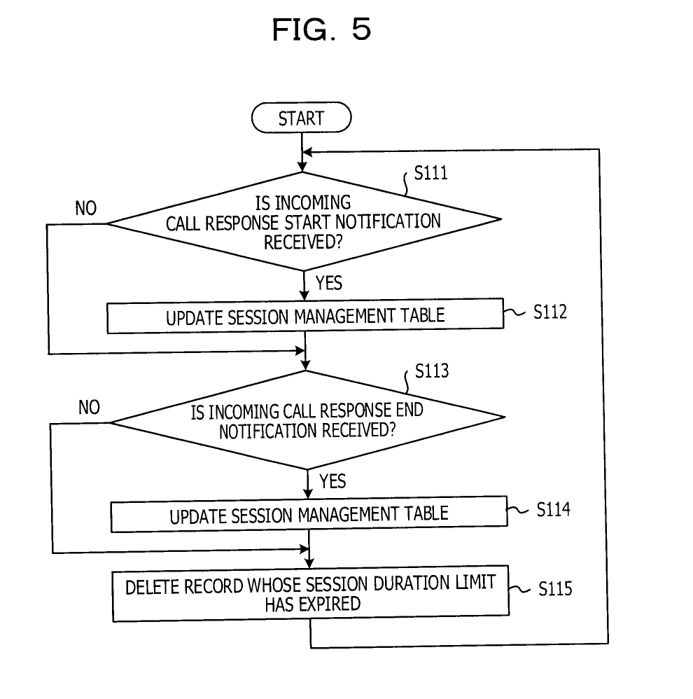

FIG. 5 is a flowchart illustrating an example of processing operation of a relay server in relation to session management processing at a time of an incoming call response. The relay server described with reference to FIG. 5 may be the relay server 400 illustrated in FIG. 1. The control unit 412 determines whether or not an incoming call response start notification is received from the user terminal 300 (S111). Incidentally, the incoming call response start notification is generated by the business app executing unit 312A in the user terminal 300 when the telephone app executing unit 312B starts a telephone call. The incoming call response start notification is then transmitted to the relay server 400. In addition, when the session duration time is determined according to the caller of an incoming call, for example, the incoming call response start notification also includes information on the telephone number of the caller. The incoming call response start notification may further include information on a time of a start of an incoming call response.

When the incoming call response start notification is received (YES in S111), the session managing unit 412A updates the session management table 413A (S112). For example, the session managing unit 412A refers to the duration time management table 413B, and obtains the session duration time (the second time interval). Then, the session managing unit 412A identifies a record corresponding to a session used to transmit the incoming call response start notification in the session management table 413A. The session managing unit 412A updates a session duration limit in the record with a time obtained by adding the session duration time to a time of reception of the incoming call response start notification.

Next, when no incoming call response start notification is received in S111 (NO in S111), or when the updating of the session management table 413A is ended in S112, the control unit 412 determines whether or not an incoming call response end notification is received from the user terminal 300 (S113). Incidentally, the incoming call response end notification is generated by the business app executing unit 312A in the user terminal 300 when the telephone app executing unit 312B ends the telephone call. The incoming call response end notification is then transmitted to the relay server 400.

When the incoming call response end notification is received (YES in S113), the session managing unit 412A updates the session management table 413A (S114). For example, the session managing unit 412A identifies the record corresponding to the session used to transmit the incoming call response end notification in the session management table 413A. The session managing unit 412A then updates the session duration limit in the record with a time obtained by adding the first time interval to a time of reception of the incoming call response end notification.

As a result of the processing of S112 and S114, the session can be maintained for a period of the second time interval from the start of the telephone call in the case where the user terminal 300 is making the telephone call, and the session can be maintained for a period of the first time interval after the telephone call is ended. That is, the present embodiment maintains the session for a period of the second time interval longer than the first time interval during the telephone call, and maintains the session for a period of the first time interval shorter than the second time interval after the end of the telephone call to make effective use of the resources of the relay server 400.

Next, when the incoming call response end notification is not received in S113 (NO in S113), or when the session management table 413A is updated in S114, the session managing unit 412A deletes the record whose session duration limit has expired from the session management table 413A (S115). The control unit 412 then returns to S111. It suffices for a method of identifying the record whose session duration limit has expired to be similar to the above-described method.

In S115, for example, the session in which the second time interval has passed since the start of the telephone call is determined to be a session whose session duration limit has expired, and the record corresponding to the session is deleted from the session management table 413A. Incidentally, S115 in FIG. 5 may be integrated into S109 in FIG. 4. That is, records whose session duration limit has expired may be deleted en bloc in the processing flow of FIG. 4, and S115 in FIG. 5 may be omitted.

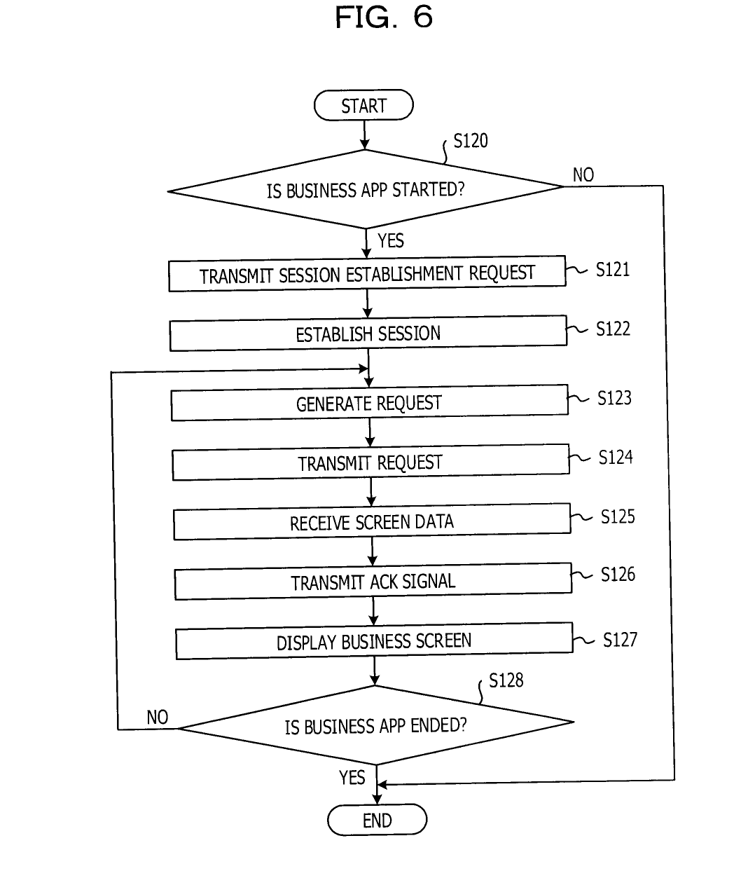

FIG. 6 is a flowchart illustrating an example of processing operation of a user terminal in relation to business screen display processing. The user terminal described with reference to FIG. 6 may be the user terminal 300 illustrated in FIG. 1. The control unit 312 determines whether or not the business app 313A is started (S120). When the business app 313A is not started (NO in S120), the processing of the present flowchart is ended.

When the business app 313A is started (YES in S120), on the other hand, the business app executing unit 312A controls the communicating unit 311 to transmit a session establishment request to the relay server 400 (S121). Then, under control of the business app executing unit 312A, the communicating unit 311 establishes a session with the relay server 400 according to a given protocol (S122).

Next, the business app executing unit 312A generates a request according to an instruction from the user (S123). Then, the business app executing unit 312A transmits the request to the relay server 400 via the communicating unit 311 (S124).

Next, when the communicating unit 311 receives screen data from the relay server 400 (S125), the communicating unit 311 transmits an Ack signal notifying the reception of the screen data to the relay server 400 under control of the business app executing unit 312A (S126). Further, the display unit 314 displays a business screen based on the received screen data under control of the business app executing unit 312A (S127).

The control unit 312 determines whether or not an instruction to end the business app 313A is given by the user (S128). When the ending instruction is given (YES in S128), the control unit 312 ends the series of pieces of processing. When the ending instruction is not given (NO in S128), on the other hand, the control unit 312 returns to S123.

However, when the session is disconnected, the transmission of the request (S124) fails. Hence, in this case, the control unit 312 may need to return to S121, and transmit a session establishment request to the relay server 400 again.

As described above, while the session is established, a request and a response are exchanged between the user terminal 300 and the business system 2 via the relay server 400, and the user is provided with a result of processing by the business system 2 as a business screen.

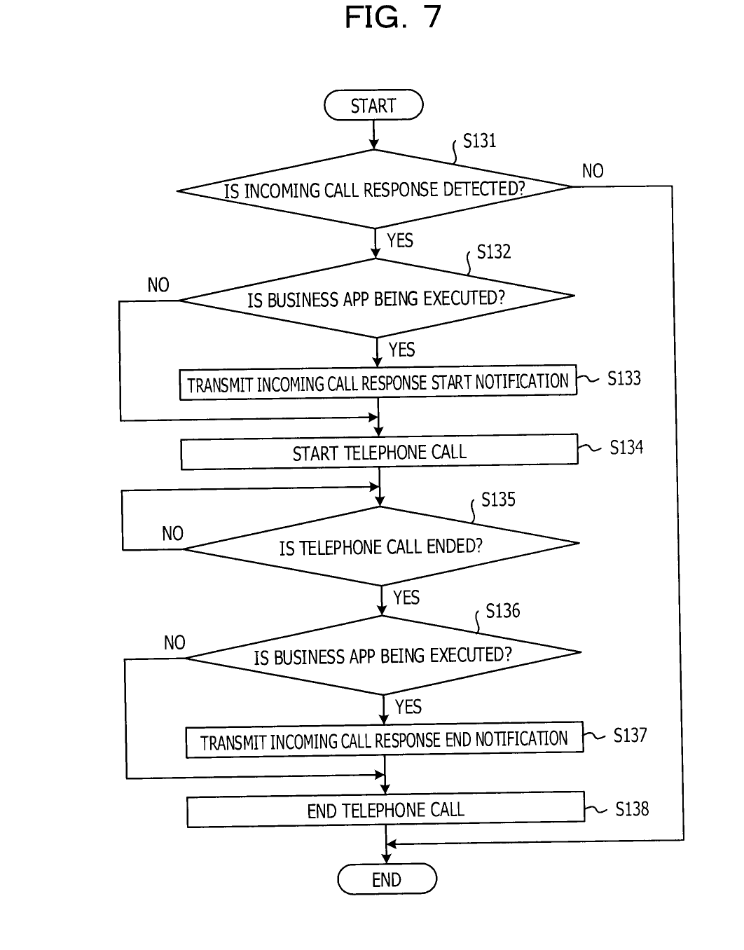

FIG. 7 is a flowchart illustrating an example of processing operation of a user terminal at a time of an incoming call response. The user terminal described with reference to FIG. 7 may be the user terminal 300 illustrated in FIG. 1. The control unit 312 determines whether or not there is an incoming call response (S131). Incidentally, when there is an incoming call response, the telephone app 313B is started. When an incoming call response is detected (YES in S131), the control unit 312 determines whether or not the business app 313A is being executed (S132).

When the business app 313A is being executed (YES in S132), the business app executing unit 312A controls the communicating unit 311 to transmit an incoming call response start notification to the relay server 400 (S133). The telephone app executing unit 312B then starts a telephone call (S134).

Next, the control unit 312 determines whether or not the telephone call is ended (S135). When the telephone call is ended (YES in S135), the control unit 312 determines whether or not the business app 313A is being executed (S136). When the business app 313A is being executed (YES in S136), the business app executing unit 312A controls the communicating unit 311 to transmit an incoming call response end notification to the relay server 400 (S137). Then, the telephone app executing unit 312B ends the telephone call (S138), and the control unit 312 ends the telephone app 313B. Incidentally, when the telephone call is not ended (NO in S135), the control unit 312 waits until the telephone call is ended.

When no incoming call response is detected in S131 (NO in S131), on the other hand, the control unit 312 ends the processing of the present flowchart. In addition, when the business app 313A is not being executed in S132 (NO in S132), the control unit 312 proceeds to S134. Further, when the business app 313A is not being executed in S136 (NO in S136), the control unit 312 proceeds to S138.

As described above, the user terminal 300 transmits an incoming call response start notification to the relay server 400 at a point in time that a response to an incoming call is started. The relay server 400 can therefore detect that the user terminal 300 has started a telephone call. Hence, the relay server 400 can extend the session duration limit of the session with the user terminal 300 during the telephone call by the second time interval longer than the first time interval. In other words, in related art, the session between the user terminal 300 and the relay server 400 is disconnected at a point in time that the first time interval has passed since the transmission of a last request or a last Ack signal during the telephone call. According to the present embodiment, on the other hand, the session is maintained for a period of the second time interval longer than the first time interval even during the telephone call. That is, according to the present embodiment, the duration time of the session between the user terminal 300 and the relay server 400 is set longer during the telephone call, and the session can be maintained until the user terminal 300 ends the telephone call.

Further, the whole or an arbitrary part of the various kinds of processing functions performed by the respective devices may be performed on a CPU (or a microcomputer such as a micro processing unit (MPU), a micro controller unit (MCU), or the like). In addition, it is needless to say that the whole or an arbitrary part of the various kinds of processing functions may be performed on a program executed by a CPU (or a microcomputer such as an MPU, an MCU, or the like) or on hardware based on wired logic.

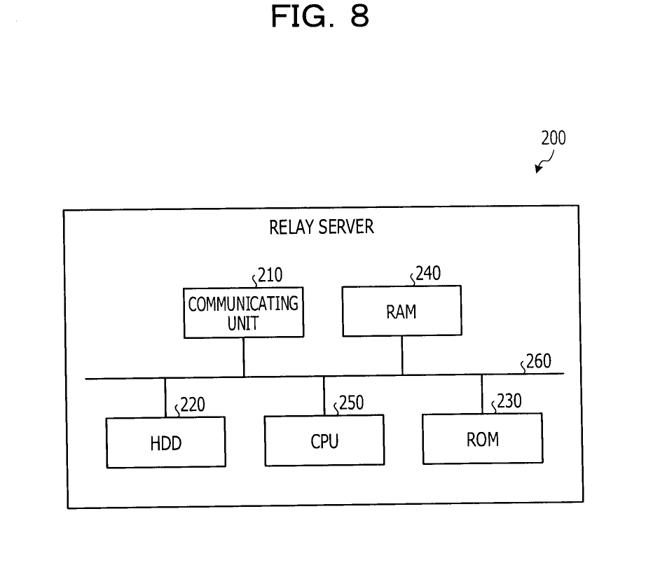

A hardware configuration of a relay server will next be described. FIG. 8 is a diagram of assistance in explaining an example of a hardware configuration of a relay server that executes a session managing program.

A relay server 200 illustrated in FIG. 8 corresponds to the relay server 400 in FIG. 1. The relay server 200 includes a communicating unit 210, an HDD 220, a ROM 230, a RAM 240, and a CPU 250. The communicating unit 210, the HDD 220, the ROM 230, the RAM 240, and the CPU 250 are coupled to each other via a bus 260.

The ROM 230 stores a session managing program describing the pieces of processing illustrated in FIG. 4 and FIG. 5. Incidentally, the session managing program may be recorded on a recording medium readable by a drive not illustrated in the figures rather than in the ROM 230. In addition, the recording medium may be for example a portable recording medium such as a compact disk read only memory (CD-ROM), a digital versatile disk (DVD), a universal serial bus (USB) memory, or the like, or a semiconductor memory such as a flash memory or the like.

The CPU 250 functions as the control unit 412 by reading out the session managing program from the ROM 230 and executing the session managing program. In addition, the communicating unit 210 functions as the relay unit 411 under control of the CPU 250. In addition, the HDD 220, the ROM 230, and the RAM 240 function as the storage unit 413 under control of the CPU 250.

### Second Embodiment

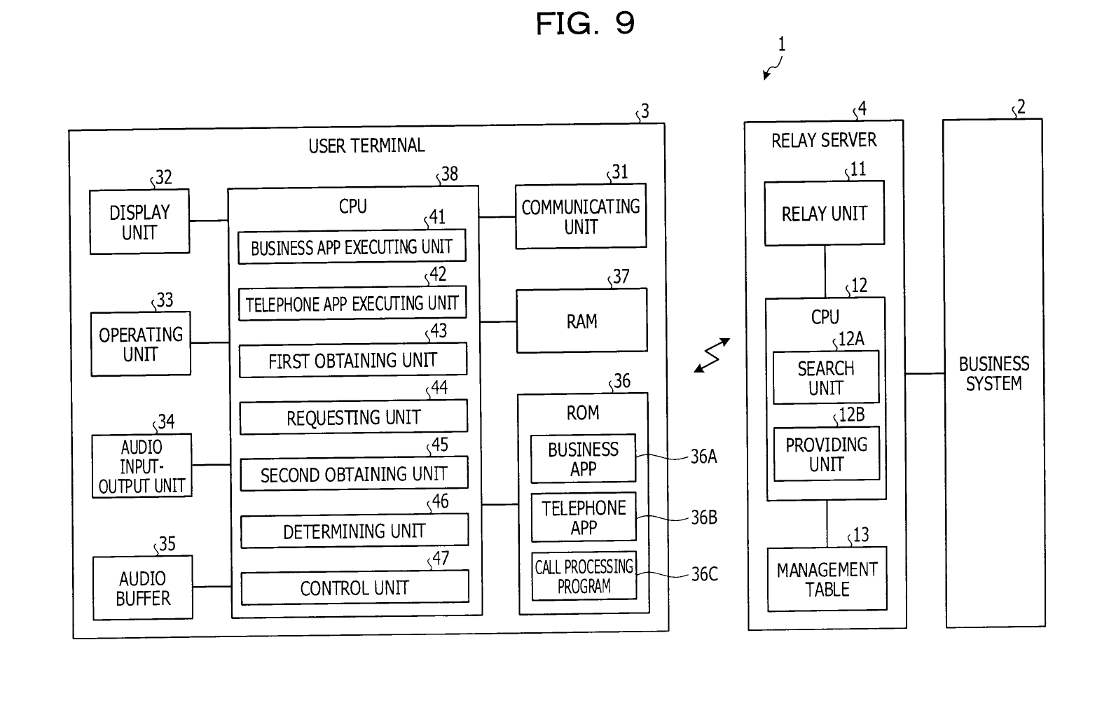

A second embodiment has a mechanism that maintains a session with a relay server 4 for a time longer than a normal time-out time even when a communicating device such as a smart phone or the like (a user terminal 3 in FIG. 9, for example) is responding to an incoming call. For example, when the user terminal 3 detects a response to an incoming call, the user terminal 3 transmits a packet to the relay server 4 to maintain a session with the relay server 4 for a certain time. For example, the packet includes a date and time of transmission of the packet, a number of times of transmission of the packet, and the like set in the header of the packet, and the packet includes an appropriate data string such as “00000000” or the like in the body of the packet.

The relay server 4 updates a session duration limit as described in the foregoing embodiment each time a packet is received. Thus, the session between the user terminal 3 and the relay server 4 is maintained even during the incoming call response by the packet received during the incoming call response. Incidentally, in the following description, the user terminal 3 moves a business app to a background according to the incoming call response. However, even after the transition to the background, a communicating unit transmits the packet to the relay server 4 under control of a CPU that is executing the business app.

FIG. 9 is a diagram of assistance in explaining an example of a BYOD system. A BYOD system 1 illustrated in FIG. 9 includes a business system 2, the user terminal 3 such as a privately owned smart device or the like, and the relay server 4. The BYOD system 1 for example accesses the business system 2 from the privately owned user terminal 3 via the relay server 4 using a specific application such as a business application (hereinafter referred to as an app) or the like, and transfers a business screen to the user terminal 3. The user terminal 3 is enabled to perform remote operation of the business system 2 via the relay server 4. Moreover, though the business screen is transferred to the user terminal 3, the business system 2 adopts a mechanism that does not leave the business screen within the user terminal 3 when the session with the user terminal 3 is disconnected.

The business system 2 is for example a specific system that manages business data within a company, and which allows various kinds of business in the company to be performed in a secure state. The user terminal 3 is for example a BYOD call terminal device such as a smart phone, a tablet, or the like that is privately owned by an employee of the company, rather than a terminal provided from the company, for example.

The relay server 4 is for example a gate way (GW) server providing a virtual web browser in a data center or the like, the server relaying between the business system 2 and the user terminal 3 in a secure state. Suppose that the relay server 4 for example couples to the user terminal 3 by radio, and couples to the business system 2 by wire. Further, the relay server 4 enables the user terminal 3 to access the business system 2 in a secure state using the business app, and transfers a business screen from the business system 2 side to the user terminal 3. Further, the relay server 4 enables the user terminal 3 to perform remote operation of the business system 2.

The relay server 4 includes a relay unit 11, a CPU 12, and a management table 13. The relay unit 11 relays business screens, commands, and the like mutually between the user terminal 3 and the business system 2. The CPU 12 controls the whole of the relay server 4.

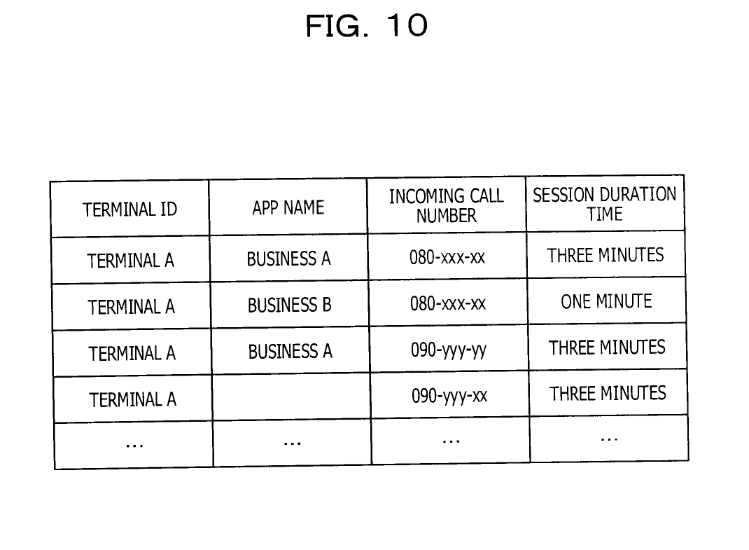

FIG. 10 is a diagram of assistance in explaining an example of a management table. The management table illustrated in FIG. 10 may be the management table 13 illustrated in FIG. 9. The management table 13 illustrated in FIG. 10 is a storage unit that manages an app name, an incoming call number, and a session duration time in association with each terminal ID for identifying a user terminal 3. The app name is information identifying a business app being executed by the user terminal 3 during an incoming telephone call. The incoming call number is the telephone number of another party as a caller of the incoming telephone call to the user terminal 3. The session duration time is a time for which the business system 2 can maintain or hold a session with the user terminal 3 from a response to the incoming telephone call by the user terminal 3, that is, from a start of a telephone call.

As illustrated in FIG. 10, for a “terminal A” as a terminal ID, a session duration time in a “business A” as an app name is set to be “three minutes” and a session duration time in a “business B” as an app name is set to be “one minute” in a case of an incoming call number of “080-xxx-xx.” In addition, for the “terminal A” as a terminal ID, in a case of an incoming call number of “090-yyy-xx,” the session duration time in all of business apps is set to be “three minutes” even when the app name is not determined. Incidentally, the contents of the management table 13 can be for example registered in advance by a registration application of the user of the user terminal 3 or the like, and the duration times can also be registered as appropriate according to loads of the business system 2.

The CPU 12 includes a search unit 12A and a providing unit 12B. The search unit 12A retrieves, from the management table 13, a session duration time corresponding to an incoming call number related to the terminal ID of the user terminal 3 in response to a time request from the user terminal 3 to be described later. The providing unit 12B is a notifying unit that provides the session duration time retrieved by the search unit 12A to the user terminal 3 that made the time request.

The user terminal 3 includes a communicating unit 31, a display unit 32, an operating unit 33, an audio input-output unit 34, an audio buffer 35, a ROM 36, a RAM 37, and a CPU 38. The communicating unit 31 is a communication interface in charge of normal radio communication and communication with the relay server 4 using the business app. The display unit 32 is an output interface that performs screen display of various kinds of information. The operating unit 33 is an input interface that inputs various kinds of commands. Incidentally, the operating unit 33 for example corresponds to a touch panel or the like that detects touch operation on the display screen of the display unit 32.

The audio input-output unit 34 for example corresponds to a microphone, a speaker, or the like, and corresponds to an input-output interface that inputs and outputs sound. The audio buffer 35 is for example an area that temporarily stores audio data using a business app 36A within the user terminal 3. The ROM 36 is an area that stores various kinds of data and various kinds of programs such for example as the business app 36A, a telephone app 36B, and the like. The business app 36A is a specific app that establishes a session with the business system 2 via the relay server 4 with the user terminal 3 as a BYOD device, enables access to the business system 2 in a secure state, and performs screen display of a business screen from the business system 2 on the display unit 32. The telephone app 36B is for example an app that implements a telephone function of the radio communication of a carrier, Internet communication, or the like. The RAM 37 is an area that stores various kinds of information.

The CPU 38 is a part that controls the whole of the user terminal 3. The CPU 38 reads out a call processing program 36C, the business app 36A, and the telephone app 36B stored in the ROM 36, and configures various kinds of processes as functions on the basis of the call processing program 36C, the business app 36A, and the telephone app 36B that are read out. The CPU 38 includes a business app executing unit 41, a telephone app executing unit 42, a first obtaining unit 43, a requesting unit 44, a second obtaining unit 45, a determining unit 46, and a control unit 47.

The business app executing unit 41 performs various kinds of processing operation related to the business app 36A on the basis of the business app 36A. The telephone app executing unit 42 performs various kinds of processing operation related to the telephone app 36B on the basis of the telephone app 36B. The first obtaining unit 43 is related to the telephone app 36B. The first obtaining unit 43 detects an incoming telephone call to the user terminal 3 through the communicating unit 31. When the first obtaining unit 43 detects an incoming telephone call, the first obtaining unit 43 obtains an incoming call number as the telephone number of the caller of the incoming telephone call. The requesting unit 44 notifies the relay server 4 of a time request requesting a duration time related to the incoming call number obtained in the first obtaining unit 43. The second obtaining unit 45 obtains the duration time related to the incoming call number which duration time is provided from the relay server 4 in response to the time request to the relay server 4.

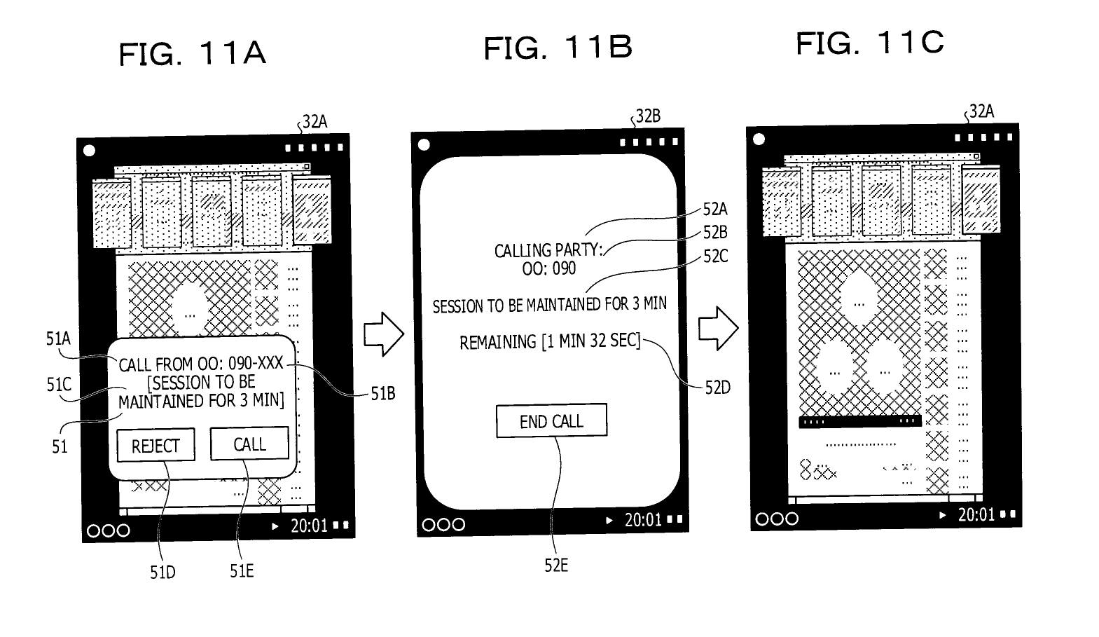

When the second obtaining unit 45 has obtained the duration time, the control unit 47 displays, on a business app screen 32A, an incoming call screen 51 displaying incoming call contents of the incoming call now being received or the like. FIGS. 11A, 11B, and 11C are diagrams of assistance in explaining an example of display screens of a user terminal. The user terminal described with reference to FIGS. 11A, 11B, and 11C may be the user terminal 3 illustrated in FIG. 9. The incoming call screen 51 illustrated in FIG. 11A includes a caller name 51A, an incoming call number 51B, a duration time 51C, a rejecting button 51D, and a telephone call button 51E. The caller name 51A is a name or the like that identifies a caller. The incoming call number 51B is the telephone number of the caller of the incoming telephone call. The duration time 51C is a session duration time. The rejecting button 51D is a button that rejects the present incoming telephone call according to a button operation. The telephone call button 51E is a button that responds to the present incoming telephone call according to a button operation. The control unit 47 moves the business app 36A to a background when detecting a button operation on the telephone call button 51E on the incoming call screen 51, that is, a response operation. Incidentally, in the transition to the background, a session between the user terminal 3 and the business system 2 is maintained through the relay server 4.

After the business app 36A is moved to the background, the determining unit 46 determines whether or not the business app 36A being executed now is an app using sound on the basis of whether or not the audio buffer 35 is being used, for example.

When the determining unit 46 determines that the audio buffer 35 is being used, the control unit 47 lowers a volume on the business app 36A side to a given level so as not to obstruct telephone conversation using the telephone app 36B. After the control unit 47 lowers the volume on the business app 36A side to the given level, the control unit 47 instructs the telephone app executing unit 42 to perform an incoming call response operation. The telephone app executing unit 42 performs an operation of responding to the incoming telephone call, and starts a telephone call with the other party. Then, the control unit 47 performs screen display of a telephone app screen 32B on the display unit 32, as illustrated in FIG. 11B. The telephone app screen 32B includes a telephone call other party name 52A, a telephone number 52B of the other party of the telephone call, a duration time 52C, a remaining time 52D, and a telephone call ending button 52E. The telephone call other party name 52A is a name identifying the other party of the telephone call. The telephone number 52B is the telephone number of the other party of the telephone call. The duration time 52C is the session duration time. The remaining time 52D is a remaining time of the duration time 52C started to be clocked from a start of the telephone call. The telephone call ending button 52E is a button that ends the telephone call according to a button operation.

When the operation of responding to the incoming telephone call by the telephone app 36B is performed, the control unit 47 starts the duration time clocking operation, and performs screen display of the remaining time 52D of the duration time on the telephone app screen 32B.

When the duration time has passed during the telephone call, the control unit 47 ends the business app 36A moved to the background. That is, the user terminal 3 disconnects the session with the business system 2 via the relay server 4.

When the telephone call of the telephone app 36B is ended before the duration time has passed, the control unit 47 moves the business app 36A moved to the background to a foreground. Then, as illustrated in FIG. 11C, the control unit 47 performs screen display of the business app screen 32A on the display unit 32 according to the transition of the business app 36A to the foreground. As a result, after the end of the telephone call, because the session with the business system 2 is continued, business using the business app 36A can be continued smoothly.

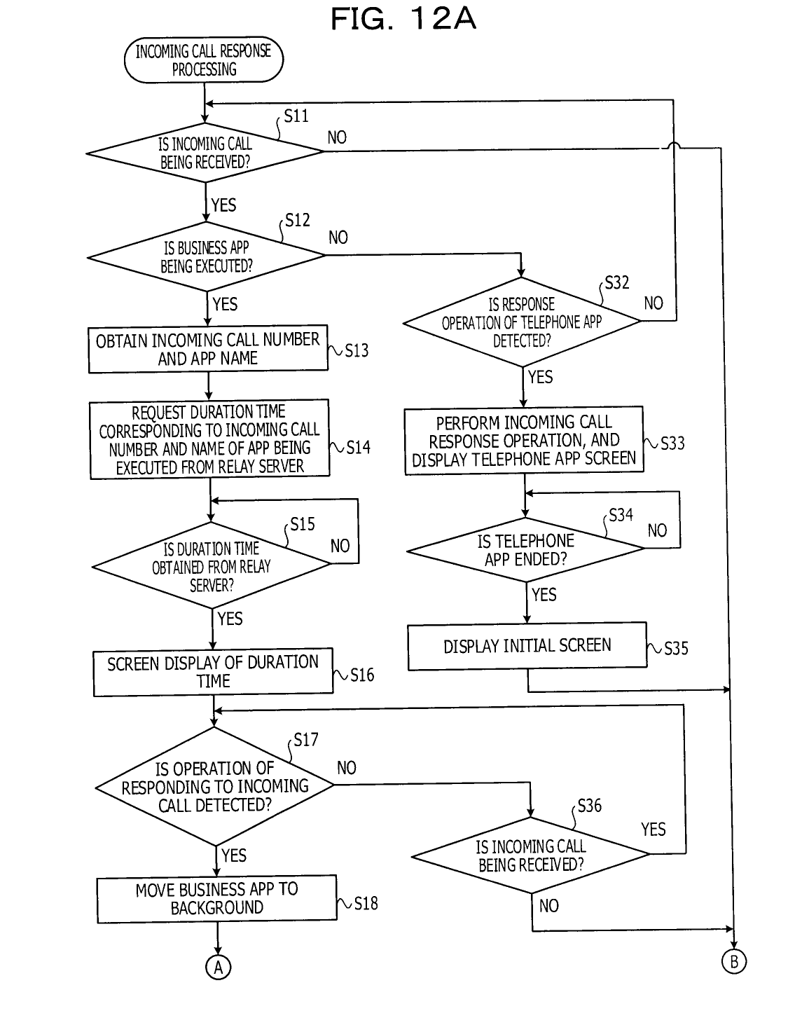

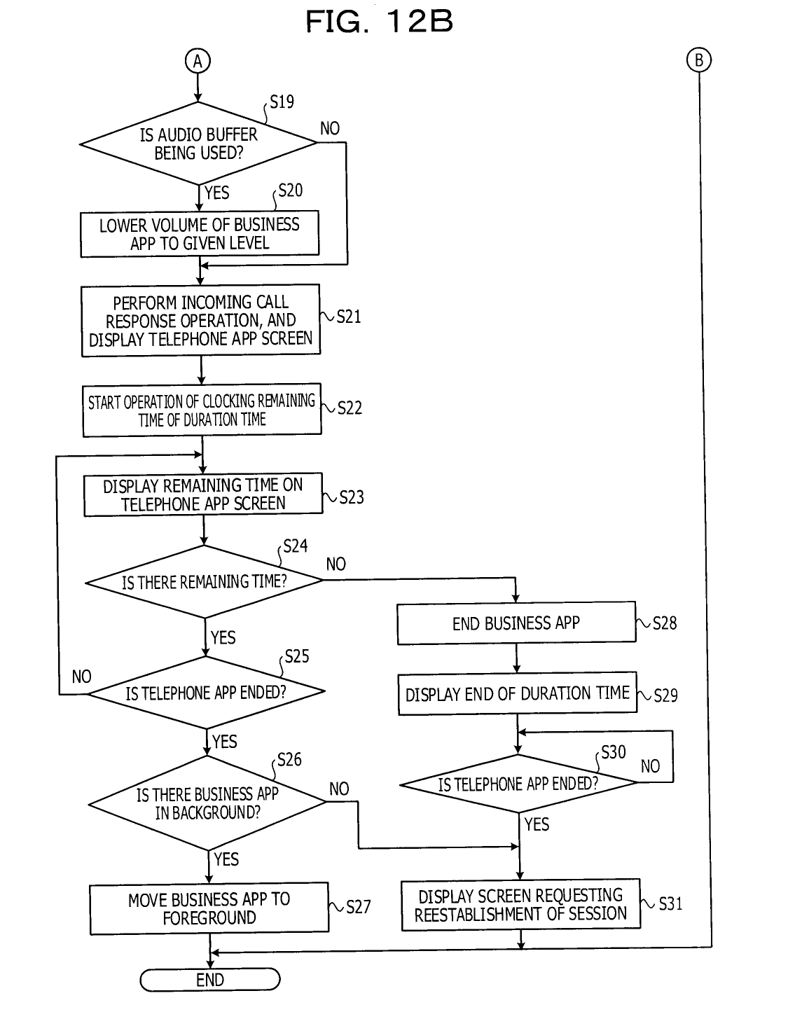

Next, operation of the BYOD system 1 according to the present embodiment will be described. FIGS. 12A and 12B are flowcharts illustrating an example of processing operation of a CPU within a user terminal in relation to incoming call response processing. The CPU and the user terminal described with reference to FIGS. 12A and 12B may be the CPU 38 and the user terminal 3, respectively, illustrated in FIG. 9. The incoming call response processing illustrated in FIGS. 12A and 12B enables, in a case where an incoming telephone call is detected during the execution of the business app, a telephone conversation for the incoming telephone call to be performed while a session with the business system 2 is maintained within the duration time related to the incoming call number of the incoming telephone call.

In FIG. 12A, the first obtaining unit 43 within the CPU 38 determines whether or not an incoming telephone call is detected (S11). When an incoming telephone call is detected (YES in S11), the first obtaining unit 43 determines whether or not the business app 36A is being executed (S12).

When the business app 36A is being executed (YES in S12), the requesting unit 44 within the CPU 38 obtains an incoming call number and the app name of the business app 36A being executed (S13). Incidentally, the requesting unit 44 obtains the incoming call number as the telephone number of a caller in response to the incoming telephone call. Further, the requesting unit 44 obtains the app name identifying the business app 36A being executed now through the business app executing unit 41 being executed now.

The requesting unit 44 requests a duration time related to the own terminal ID and the incoming call number from the relay server 4 (S14). Incidentally, the relay server 4 retrieves, from the management table 13, the duration time related to the terminal ID and the incoming call number according to providing processing to be described later. The second obtaining unit 45 determines whether or not the duration time related to the terminal ID and the incoming call number is obtained from the relay server 4 (S15).

When the duration time is obtained (YES in S15), the second obtaining unit 45 performs screen display of the incoming call screen 51 displaying the obtained duration time 51C and incoming call contents as illustrated in FIG. 11A on the business app screen 32A (S16).

The control unit 47 determines through the telephone app executing unit 42 whether or not a button operation on the telephone call button 51E within the incoming call screen 51, that is, a response operation is detected (S17). When the response operation is detected (YES in S17), the control unit 47 moves the business app 36A being executed to the background (S18). Incidentally, because the business app 36A is moved to the background, the user terminal 3 continues the session with the business system 2.

The determining unit 46 determines whether or not the audio buffer 35 is being used (S19). Incidentally, when the audio buffer 35 is being used, the control unit 47 recognizes that the business app 36A using sound is being executed. The business app 36A using sound includes an app for Web conferences, an app for moving image contents, and the like. When the audio buffer 35 is being used (YES in S19), the control unit 47 lowers the volume of the business app 36A to a given level through the business app executing unit 41 (S20).

The control unit 47 performs an operation of responding to the incoming telephone call through the telephone app executing unit 42, and performs screen display of the telephone app screen 32B on the display unit 32 as illustrated in FIG. 11B (S21). After performing the screen display of the telephone app screen 32B, the control unit 47 starts an operation of clocking a remaining time in the duration time (S22).

The control unit 47 performs screen display of the remaining time 52D of the duration time on the telephone app screen 32B according to the remaining time clocking operation (S23). Incidentally, the user on the user terminal 3 side can recognize the remaining time of the duration time by viewing the remaining time 52D within the telephone app screen 32B. The control unit 47 determines whether or not the duration time has passed, that is, whether or not there is a remaining time in the duration time (S24). When there is a remaining time (YES in S24), the control unit 47 determines through the telephone app executing unit 42 whether or not the telephone app 36B is ended (S25). Incidentally, the control unit 47 ends the telephone call, that is, ends the telephone app 36B, in response to a button operation on the telephone call ending button 52E on the telephone app on screen 32B.

When the telephone app 36B is ended (YES in S25), the control unit 47 determines whether or not the business app 36A in the background is detected (S26). When the business app 36A in the background is detected (YES in S26), the control unit 47 returns the business app 36A to the foreground (S27), and ends the processing operation illustrated in FIGS. 12A and 12B. As a result, the user of the user terminal 3 can continue to use the business app 36A while maintaining the session with the business system 2. The user of the user terminal 3 is therefore free from a burden of an operation for coupling to the business system 2.

In addition, when there is no remaining time in the duration time (NO in S24), the control unit 47 ends the business app 36A moved to the background through the business app executing unit 41 (S28). After ending the business app 36A, the control unit 47 performs screen display of an end of the duration time on the telephone app screen 32B (S29), and determines whether or not the telephone app 36B is ended (S30). Incidentally, the user can recognize the end of the duration time, that is, the disconnection of the session with the business system 2, by viewing the display of the end of the duration time.

The control unit 47 waits until the telephone app 36B is ended (NO in S30). When the telephone app 36B is ended (YES in S30), the control unit 47 switches from the telephone app screen 32B to a screen requesting the establishment of a session with the business system 2 (S31), and ends the processing operation illustrated in FIGS. 12A and 12B. Incidentally, the user of the user terminal 3 can reestablish a session with the business system 2 by inputting a login ID and a password or the like on the request screen.

When the telephone app 36B is not ended (NO in S25), the control unit 47 proceeds to S23 to display the remaining time 52D on the telephone app screen 32B. When the business app 36A in the background is not detected (NO in S26), the control unit 47 proceeds to S31 to switch display to the request screen.

When no incoming telephone call is detected (NO in S11), the first obtaining unit 43 ends the processing operation illustrated in FIGS. 12A and 12B. When the business app 36A is not being executed (NO in S12), the control unit 47 determines through the telephone app executing unit 42 whether or not an operation of responding to the incoming telephone call is detected (S32).

When the operation of responding to the incoming telephone call is detected (YES in S32), the control unit 47 performs an incoming call response operation, performs screen display of the telephone app screen 32B on the display unit 32 (S33), and determines whether or not the telephone app 36B is ended (S34). When the telephone app 36B is ended (YES in S34), the control unit 47 switches the display of the display unit 32 from the telephone app screen 32B to an initial screen (S35), and ends the processing operation illustrated in FIGS. 12A and 12B. Incidentally, the initial screen is a so-called standby screen.

When the operation of responding to the incoming telephone call is not detected (NO in S32), the control unit 47 proceeds to S11 to determine whether or not the incoming telephone call is being received. When the telephone app 36B is not ended (NO in S34), the control unit 47 proceeds to S34 to determine whether or not the telephone app 36B is ended.

When the duration time related to the terminal ID and the incoming call number is not obtained from the relay server 4 (NO in S15), the control unit 47 proceeds to S15 to determine whether or not the duration time is obtained.

When the operation of responding to the incoming telephone call is not detected (NO in S17), the control unit 47 determines whether or not the incoming call is now being received (S36). When the incoming call is now being received (YES in S36), the control unit 47 proceeds to S17 to determine whether or not the operation of responding to the incoming telephone call is detected. When the incoming call is not being received now (NO in S36), the control unit 47 ends the processing operation illustrated in FIGS. 12A and 12B.

When the audio buffer 35 is not being used (NO in S19), the control unit 47 proceeds to S21 to perform the operation of responding to the incoming telephone call through the telephone app executing unit 42, and switch display from the business app screen 32A to the telephone app screen 32B.

When an incoming telephone call is detected while the business app is being executed, the control unit 47 that performs the incoming call response processing illustrated in FIGS. 12A and 12B requests the duration time related to the terminal ID of the own terminal and the incoming call number from the relay server 4, and performs screen display of the duration time on the telephone app screen 32B. As a result, the user can recognize the duration time of a session with the business system 2 before an incoming call response by viewing the duration time 52C on the telephone app screen 32B.

When the operation of responding to the incoming telephone call is detected on the telephone app screen 32B, the control unit 47 moves the business app 36A to the background, lowers the volume of the business app 36A in the case where the audio buffer 35 is being used, and performs the operation of responding to the incoming telephone call. As a result, the user can respond to the incoming telephone call while maintaining the session with the business system 2. Moreover, reducing the mixing of sound produced by the business app 36A enables the telephone call of the telephone app 36B to be performed smoothly while the session with the business system 2 is maintained.

The control unit 47 performs the operation of responding to the incoming telephone call in the case where the audio buffer 35 is not being used. As a result, the user can respond to the incoming telephone call while maintaining the session with the business system 2.

Further, the control unit 47 performs the operation of responding to the incoming telephone call, and performs screen display of the remaining time of the duration time on the telephone app screen 32B. As a result, the user can recognize the remaining time of the duration time of the session with the business system 2 by viewing the remaining time on the telephone app screen 32B.

When the telephone call is ended before the passage of the duration time, the control unit 47 moves the business app 36A in the background to the foreground. As a result, the user can continue the business app 36A because the session with the business system 2 is maintained even after the end of the telephone call.

In the case where the telephone call is ended after the passage of the duration time, the control unit 47 can maintain the telephone call while the session with the business system 2 is disconnected after the passage of the duration time. As a result, the business system 2 can reduce a processing load resulting from indiscriminately maintaining sessions.

Further, in the case where the telephone call is ended after the passage of the duration time, the control unit 47 performs screen display of the end of the duration time on the telephone app screen 32B. As a result, the user can recognize the end of the duration time, that is, the disconnection of the session with the business system 2 by viewing the end of the duration time on the telephone app screen 32B.

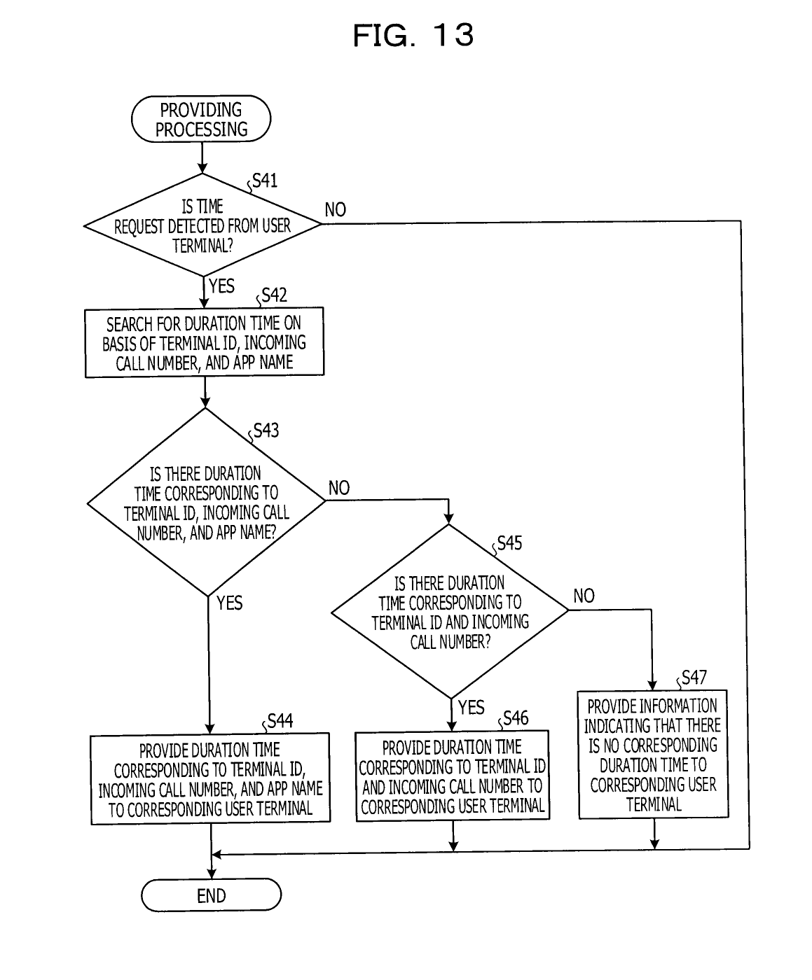

FIG. 13 is a flowchart illustrating an example of processing operation of a CPU within a relay server in relation to providing processing. The CPU and the relay server described with reference to FIG. 13 may be the CPU 12 and the relay server 4, respectively, illustrated in FIG. 9. The providing processing illustrated in FIG. 13 retrieves, from the management table 13, a duration time related to an incoming call number, and provides the duration time to the user terminal 3, in response to a time request related to the incoming call number of an incoming telephone call from the user terminal 3.

In FIG. 13, the CPU 12 of the relay server 4 determines whether or not a time request is detected from the user terminal 3 (S41). Incidentally, the time request includes the terminal ID identifying the user terminal 3 making the time request, the incoming call number of the incoming telephone call to the user terminal 3, and the app name identifying the business app 36A being executed on the user terminal 3.

When the time request is detected (YES in S41), the search unit 12A within the CPU 12 searches the management table 13 for a duration time on the basis of the terminal ID, the incoming call number, and the name of the business app in the time request (S42). The search unit 12A determines whether or not there is a session duration time corresponding to the terminal ID, the incoming call number, and the app name within the management table 13 (S43).

When there is a session duration time corresponding to the terminal ID, the incoming call number, and the app name (YES in S43), the providing unit 12B within the CPU 12 provides the session duration time to the corresponding user terminal 3 (S44), and ends the processing operation illustrated in FIG. 13.

When there is no session duration time corresponding to the terminal ID, the incoming call number, and the app name within the management table 13 (NO in S43), the search unit 12A determines whether or not there is a session duration time corresponding to the terminal ID and the incoming call number within the management table 13 (S45).

When there is a session duration time corresponding to the terminal ID and the incoming call number within the management table 13 (YES in S45), the providing unit 12B provides the session duration time to the corresponding user terminal 3 (S46), and ends the processing operation illustrated in FIG. 13.

When there is no session duration time corresponding to the terminal ID and the incoming call number within the management table 13 (NO in S45), the search unit 12A provides information indicating that there is no corresponding duration time to the corresponding user terminal 3 (S47), and ends the processing operation illustrated in FIG. 13. When no time request is detected from the user terminal 3 (NO in S41), the CPU 12 ends the processing operation illustrated in FIG. 13.

The CPU 12 of the relay server 4 that performs the providing processing illustrated in FIG. 13 can obtain, from the management table 13, the duration time corresponding to the terminal ID, the app name, and the incoming call number in the time request, and provide the obtained duration time to the user terminal 3, in response to the time request from the user terminal 3.

The CPU 12 can obtain, from the management table 13, the duration time corresponding to the terminal ID and the incoming call number in the time request, and provide the obtained duration time to the user terminal 3.

When there is no duration time corresponding to the terminal ID and the incoming call number in the time request within the management table 13, the CPU 12 can provide information indicating that there is no corresponding duration time to the user terminal 3.

When an incoming telephone call is detected during a session with the business system 2 in which session the business app 36A is used, the user terminal 3 according to the present embodiment obtains the incoming call number of the incoming telephone call, and obtains the duration time corresponding to the incoming call number from the relay server 4. Further, obtaining the duration time, the user terminal 3 moves the business app 36A to the background so as to maintain the session with the business system 2 within the duration time, and allows telephone conversation for the incoming telephone call, according to a response to the incoming telephone call. As a result, the duration of the session with the business system 2 and telephone call connection are made compatible with each other. Thus, the convenience of the user and a reduction in the load of the business system 2 are made compatible with each other.

When the telephone call is ended before the passage of the duration time from the response to the incoming telephone call, the user terminal 3 moves the business app 36A from the background to the foreground. As a result, the business app 36A can be resumed smoothly after the end of the telephone call.

When the telephone call is ended after the passage of the duration time from the response to the incoming telephone call, the user terminal 3 displays a screen requesting the reestablishment of a session with the business system 2 by using the business app 36A. As a result, the business app 36A can be resumed by an input operation on the screen requesting the reestablishment.

When the duration time has passed since the response to the incoming telephone call, the user terminal 3 disconnects the session with the business system 2. As a result, the time of the session with the business system 2 is limited. A processing load on the business system 2 side due to the holding of sessions can therefore be reduced.

When the business app 36A is an app using sound, the user terminal 3 lowers the volume of the business app 36A to a given level. Therefore, the telephone call can preferably be prevented from being obstructed by the sound of the business app 36A in the background.

The user terminal 3 performs screen display of the remaining time as notice information giving notice of the passage of the duration time while the business app 36A is in the background. As a result, the user of the user terminal 3 can recognize the remaining time of the duration time by viewing the remaining time.

Incidentally, while a duration time corresponding to the terminal ID, the incoming call number, and the app name is requested from the relay server 4 in S14 in FIG. 12A in the above-described embodiment, a duration time corresponding to the terminal ID and the incoming call number irrespective of the app name may be requested. Similarly, a duration time corresponding to the incoming call number irrespective of the terminal ID and the app name may be requested.

Further, the user terminal 3 may retain the management table according to the second embodiment. In this case, the second obtaining unit 45 obtains the duration time corresponding to the incoming call number and the like from the management table without inquiring of the relay server 4.

In addition, the constituent elements of the units illustrated in the figures do not necessarily need to be physically configured as illustrated in the figures. That is, specific forms of distribution and integration of the units are not limited to the specific forms illustrated in the figures, but the whole or a part of the units can be configured to be distributed or integrated functionally or physically in arbitrary units according to various kinds of loads, usage conditions, and the like.

Further, the whole or an arbitrary part of various kinds of processing functions performed in the respective devices may be performed on a CPU (or a microcomputer such as an MPU, an MCU, or the like). In addition, it is needless to say that the whole or an arbitrary part of the various kinds of processing functions may be performed on a program executed by the CPU (or the microcomputer such as the MPU, the MCU, or the like), or performed on hardware based on wired logic.

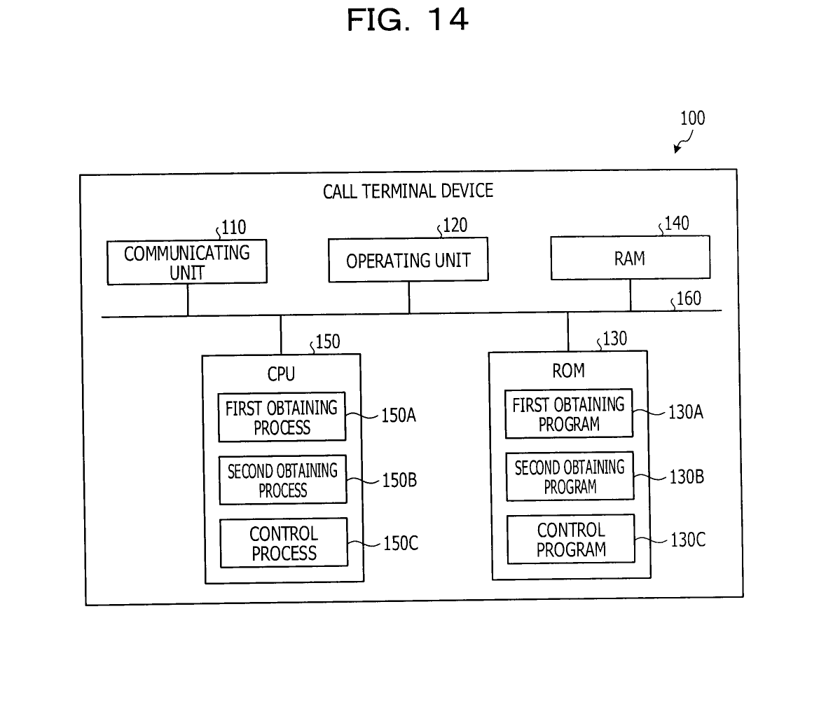

The various kinds of processing described in the present embodiments can be implemented by making a processor such as a CPU or the like within a terminal device execute a program prepared in advance. Accordingly, the following description will be made of an example of a call terminal device that executes a program having functions similar to the functions of the foregoing embodiments. FIG. 14 is a diagram of assistance in explaining an example of a call terminal device that executes a call processing program.

A call terminal device 100 that executes a call processing program illustrated in FIG. 14 includes a communicating unit 110, an operating unit 120, a ROM 130, a RAM 140, and a CPU 150. The communicating unit 110, the operating unit 120, the ROM 130, the RAM 140, and the CPU 150 are connected to each other via a bus 160.

The ROM 130 stores, in advance, the call processing program that exerts functions similar to the functions of the foregoing embodiments. The ROM 130 stores, as the call processing program, a first obtaining program 130A, a second obtaining program 130B, and a control program 130C. Incidentally, the call processing program may be recorded on a recording medium readable by a drive not illustrated in the figures rather than in the ROM 130. In addition, the recording medium may be for example a portable recording medium such as a CD-ROM, a DVD, a USB memory, or the like, or a semiconductor memory such as a flash memory or the like.

The CPU 150 functions as a first obtaining process 150A by reading out the first obtaining program 130A from the ROM 130. Further, the CPU 150 functions as a second obtaining process 150B by reading out the second obtaining program 130B from the ROM 130. The CPU 150 functions as a control process 150C by reading out the control program 130C from the ROM 130.

When the call terminal device 100 detects an incoming telephone call during a session with a specific system in which session a specific application is used, the call terminal device 100 obtains the incoming call number of the incoming telephone call. The call terminal device 100 obtains, from a server, a duration time for which the session with the specific system can be maintained, the duration time corresponding to the incoming call number. Obtaining the duration time, the call terminal device 100 moves the specific application to a background so as to maintain the session with the specific system within the duration time, and allows a telephone conversation for the incoming telephone call, according to a response to the incoming telephone call. As a result, the duration of the session with the specific system and telephone call connection can be made compatible with each other.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A session managing method executed by a session managing device, the session managing method comprising:
establishing a session with a communicating device in response to a first request from the communicating device;
extending a duration limit of the session by a first time interval according to an actual result of communication between the communicating device and the session managing device; and
extending the duration limit of the session by a second time interval longer than the first time interval when receiving, from the communicating device, a notification indicating that a telephone call with another communicating device is started.

2. The session managing method according to claim 1, wherein
the session managing device is a relay device that relays communication between the communicating device and a system.

3. The session managing method according to claim 2, further comprising:
transferring, to the system, a second request from the communicating device to the system;
obtaining a result of processing by the system in response to the second request; and
transmitting screen data of a screen that displays the processing result to the communicating device.

4. The session managing method according to claim 1, further comprising:
disconnecting the session when the duration limit extended by one of the first time interval and the second time interval has passed.

5. The session managing method according to claim 1, wherein
the second time interval is set according to at least one of the communicating device and the another communicating device.

6. A call processing method executed by a communicating device, the call processing method comprising:
establishing a session between a server and the communicating device using a specific application for obtaining a processing result of the server; and
when an incoming call from a different communicating device is received while the session is maintained, moving the specific application to a background; and
maintaining the session with the server within a given time during a telephone call for the incoming call.

7. The call processing method according to claim 6, wherein
the session is maintained by a packet transmitted to the server at each given time interval within the given time.

8. The call processing method according to claim 6, further comprising:
moving the specific application from the background to a foreground when the telephone call is ended before passage of the given time from a response to the incoming call.

9. A session managing system comprising:
circuitry configured to:
establish a session with a communicating device in response to a first request from the communicating device,
extend a duration limit of the session by a first time interval according to an actual result of communication between the communicating device and the session managing device, and
extend the duration limit of the session by a second time interval longer than the first time interval when receiving, from the communicating device, a notification indicating that a telephone call with another communicating device is started.

10. The session managing system according to claim 8, wherein
the session managing device is a relay device that relays communication between the communicating device and another system.

11. The session managing system according to claim 10, wherein the circuitry is configured to:
transfer, to the another system, a second request from the communicating device to the another system,
obtain a result of processing by the another system in response to the second request, and
transmit screen data of a screen that displays the processing result to the communicating device.

12. The session managing system according to claim 9, wherein the circuitry is configured to:
disconnect the session when the duration limit extended by one of the first time interval and the second time interval has passed.

13. The session managing system according to claim 9, wherein
the second time interval is set according to at least one of the communicating device and the another communicating device.
